(19) United States
(12) Patent Application Publication
(10) Pub. No.: US 2025/0065811 A1
(43) Pub. Date: Feb. 27, 2025

(54) RECREATIONAL VEHICLE WITH A PIECE OF FURNITURE AND A CONNECTING ELEMENT FOR FURNITURE OF RECREATIONAL VEHICLES

(71) Applicant: Thor Tech, Inc., Elkhart, IN (US)

(72) Inventors: Erik Plischke, Missen-Willhams (DE); Thomas Schuster, Hergenweiler (DE); Marius Schöll, Bad Hindelang (DE)

(73) Assignee: Thor Tech, Inc., Elkhart, IN (US)

(21) Appl. No.: 18/813,937

(22) Filed: Aug. 23, 2024

(30) Foreign Application Priority Data
Aug. 25, 2023 (DE) 10 2023 122 943.5

(51) Int. Cl. B60R 7/08; A47B 96/06

(52) U.S. Cl. CPC B60R 7/08; A47B 96/06

(57) ABSTRACT

A connecting element for pieces of furniture of recreational vehicles, in particular motorhomes or caravans, comprising a main body which comprises an at least approximately L-shaped part having a first leg and a second leg, wherein on the first leg an outwardly directed tongue strip is provided, at which fastening of the main body to a profile is enabled, and wherein on the second leg at least one fastening point is provided, at which fastening of the main body to a panel is enabled. Furthermore, a piece of furniture, a recreational vehicle, and a method are specified.

The invention relates to a recreational vehicle, in particular a motorhome or a caravan. In this context, connecting elements are provided for a furniture construction. The invention also relates to such a connecting element and to pieces of furniture having connecting elements.

In a conventional RV furniture construction, complex connection techniques using cup connectors or corner connectors can be used. In this case, different screws and screw lengths in numerous variations may be required. Furthermore, certain structural conditions must be created for the connection technology in wood so that the connections hold, which is demonstrated, for example, by a doubling of material for hinges.

It is also conceivable that aluminum, wood and plastic are used for a furniture construction. Solid structures can be screwed with aluminum cross profiles and mainly drawers and shaped parts.

Also conceivable is a furniture construction composed of aluminum panels with a corrugated core. Accessibility in the living space can be achieved by means of drawers made of aluminum panels with a corrugated core in plastic profiles. A screw connection is used here.

The following problems may arise with such designs. First, a high weight and a large variety of parts arise, and adaptation to different vehicle chassis is inflexible. Furthermore, a high level of complexity for the installer arises, which results in high training requirements and high costs.

There can be a high potential for errors due to different connecting elements. Furthermore, incorrect screw lengths are often used, causing panels to be penetrated where this is not wanted. In addition, corner connectors or cup connectors may be screwed improperly and therefore in particular too weakly. In addition, the furniture construction as a whole can become rather unsafe due to improper screwing.

The object of the invention is to provide a connecting element, a piece of furniture, a recreational vehicle, in particular a motorhome or a caravan, and a method for producing a piece of furniture which enable an improved design and functionality.

The object is achieved by a connecting element having the features of independent claim 1, a piece of furniture having the features of claim 10, a recreational vehicle having the features of claim 12, and a method according to claim 13. Advantageous developments of the invention are specified in the dependent claims.

The object is achieved by a connecting element for pieces of furniture of recreational vehicles, in particular motorhomes or caravans, comprising a main body which comprises an at least approximately L-shaped part having a first leg and a second leg, wherein on the first leg an outwardly directed tongue strip is provided, at which fastening of the main body to a profile is enabled, and wherein on the second leg at least one fastening point is provided, at which fastening of the main body to a panel is enabled.

The profile and the panel are not components of the connecting element according to the invention.

The object is also achieved by a piece of furniture for recreational vehicles, in particular motorhomes or caravans, comprising at least one profile frame, multiple panels, and multiple connecting elements designed as mentioned above, wherein the main bodies of the connecting elements are fastened to profiles of the profile frame by means of the tongue strips and wherein the panels are connected to the main bodies by means of at the fastening points of the second legs.

The object is also achieved by a recreational vehicle, in particular a motorhome or a caravan, comprising at least one such piece of furniture.

It is advantageous that the main body has a rib which connects the first leg to the second leg. The rib can advantageously be used to support shelves.

It is advantageous that the rib is oriented at least approximately perpendicular to the first leg and/or that the rib is oriented at least approximately perpendicular to the second leg. This makes a right-angled orientation possible. As a result, pieces of furniture, in particular cabinets, can advantageously be constructed.

It is advantageous that the rib is connected, at its edge, to the first leg and the second leg at least substantially without gaps. This enables high stability. Furthermore, a monolithic design of the main body is enabled.

It is advantageous that the rib has at least one fastening point at which fastening of the shelf to the main body is enabled. The fastening point can be in the form of a bore in particular. This allows the shelves to be reliably fastened to the main body.

It is advantageous that the fastening point provided on the second leg is in the form of a bore. This enables, in particular, a screw connection to panels.

It is advantageous that a locking mechanism, in particular a screw connection, which serves to lock the tongue strip in the profile can be actuated at the first leg from the inside. By means of the screw connection, the axes can advantageously be locked.

It is advantageous that the main body is at least substantially monolithic. This enables a high mechanical load-bearing capacity to be achieved.

In the case of a design as a piece of furniture, it is correspondingly advantageous that at least one shelf is provided and that the shelf is connected to the main body at fastening points provided on ribs of the main bodies. As a result, a piece of furniture can advantageously be constructed.

Depending on the design and functionality, one or more of the following features and advantages can be realized. A connecting element, in particular a corner connector, can be advantageously realized. The tongue strip can serve as a tongue for aluminum profiles. The rib can serve as a support for a shelf and/or for fastening a shelf. The connecting element, in particular the corner connector, can be designed for a large part of all connections in the furniture construction in question. The connecting element can be used universally so that the number of components required is reduced. Pre-mounting on the necessary panels can first be carried out. This can be done regardless of whether it is a side wall, a center wall, a bottom or an upper panel. The pre-assembled components can then be inserted into the profile frame or the profile system and fixed.

This makes improved crash safety possible due to a more solid construction and metric connections. The variety of parts of the panel wall can be greatly reduced. The necessary stability-providing connection technology can be reduced and simplified. Due to the reduced variants, increased repeatability is possible.

Possible areas of application are in a permanently mounted furniture construction between a kitchen and a tall cabinet. In another application, a permanently mounted tall cabinet can be combined with a removable kitchen module. In a half-height variant, the furniture construction can be at a continuous height without a tall cabinet. Furthermore, a box system can be realized.

Also conceivable is a design in recreational vehicles in the form of a camper van. A lightweight and easy-to-assemble piece of furniture as well as a system for connecting panels can be created. The application is multifunctional. A correspondingly designed production method can also be claimed. The number of parts can be reduced.

Further advantages and details of the invention are explained in more detail with reference to the exemplary embodiments shown in the schematic figures. In the figures:

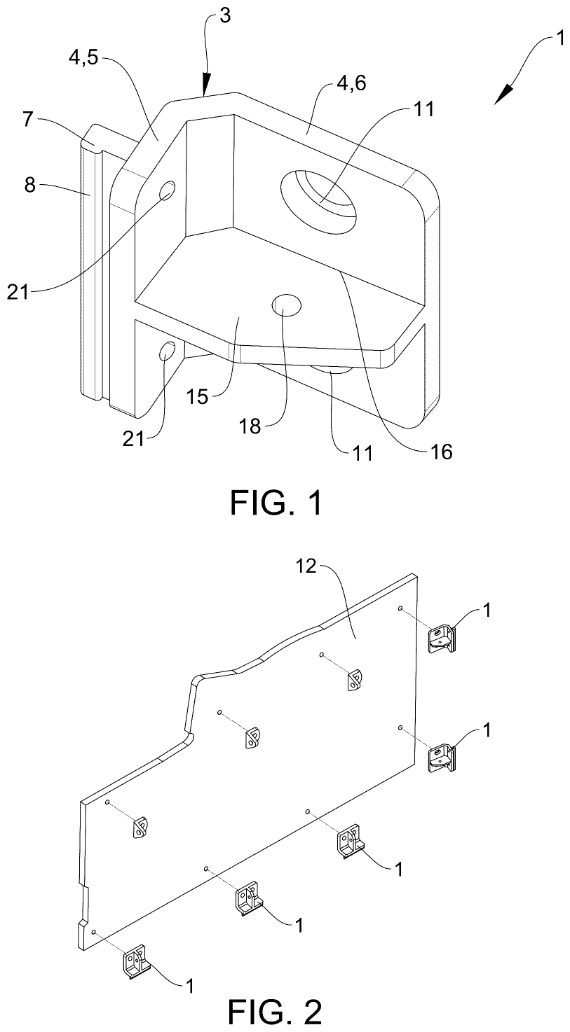

FIG. 1 shows a main body in a schematic, spatial representation according to one exemplary embodiment of the invention;

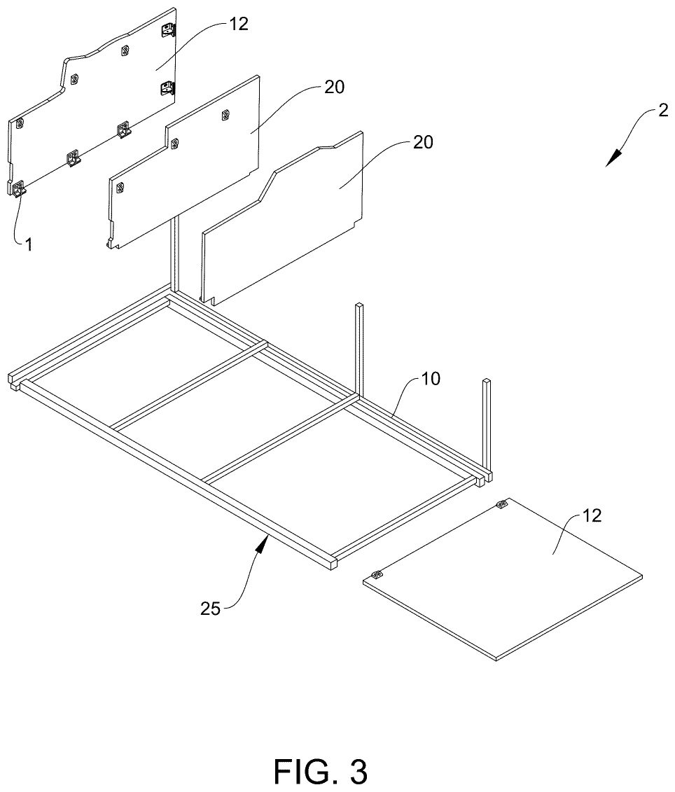

FIG. 2 shows a panel with multiple connecting elements to illustrate the assembly; and

FIG. 3 shows a piece of furniture for a recreational vehicle during assembly.

FIG. 1 shows a connecting element 1 for pieces of furniture 2 (FIG. 3) of recreational vehicles in a schematic, spatial representation according to one exemplary embodiment. The recreational vehicle can be in particular a motorhome or caravan. The connecting element and the described piece of furniture 2 are particularly suitable for such recreational vehicles.

The connecting element 1 has a main body 3, which in this exemplary embodiment comprises an L-shaped part 4 having a first leg 5 and a second leg 6. On the first leg 5 an outwardly directed tongue strip 7 with an engagement lip 8 is provided. By means of the tongue strip 7, the main body 3 can be fastened to a profile 10 (FIG. 3). In this exemplary embodiment, on the second leg 6 two fastening points 11 in the form of bores 11 are provided, at which the main body 3 is fastened to a panel 12 (FIG. 2). In general, multiple connecting elements 1 are mounted on a panel 12. The panel 12 can be, for example, a top panel, a bottom panel or a side panel.

The main body 3 also has a rib 15 which connects the first leg 5 to the second leg 6. The rib 15 is oriented both perpendicular to the first leg 5 and perpendicular to the second leg 6. In addition, the rib 15 is connected, at its edge 16, to the two legs 5, 6, without gaps. This results in a high load-bearing capacity of the main body 3.

In this exemplary embodiment, the rib 15 has a fastening point 18 in the form of a bore 18. Via the fastening point 18, a shelf 20 (FIG. 3) can be fastened to the main body 3 by means of the rib 15. In particular, the shelf 20 can be screwed on. Correspondingly, the fastening points 11 in the form of bores 11 can be used for screwing the second leg 6 onto the panel 12, as is also shown in FIG. 2.

FIG. 2 shows an example of a panel 12 with multiple connecting elements 1 which are screwed onto the panel 12.

FIG. 3 shows a piece of furniture 2 during assembly in an excerpted, schematic, spatial representation. Multiple panels 12 and multiple connecting elements 1 are used. The main bodies 3 of the connecting elements 1 are fastened to the profiles 10 of the profile frame 25 by means of the tongue strips 7. The main bodies 3 are preferably pre-mounted on the panels 12 beforehand. In the assembled state, the panels 12 are then connected to the profile frame 25 by means of the main bodies 3. The shelves 20 can be installed in a similar manner.

The panel 12 shown in FIG. 2 can, for example, be in the form of a side wall which holds the shelves 20 (FIG. 3) on one side by means of the connecting elements 1. An element designed with mirror symmetry to the panel 12 in FIG. 2 with the connecting elements 1 can fix the shelves on the other side.

The invention is not limited to the exemplary embodiments described.

1. A connecting element for pieces of furniture of recreational vehicles, in particular motorhomes or caravans, comprising a main body which comprises an at least approximately L-shaped part having a first leg and a second leg, wherein on the first leg an outwardly directed tongue strip is provided, at which fastening of the main body to a profile is enabled, and wherein on the second leg at least one fastening point is provided, at which fastening of the main body to a panel is enabled.

2. The connecting element according to claim 1,
characterized in that
the main body has a rib which connects the first leg to the second leg.

3. The connecting element according to claim 2,
characterized in that
the rib is oriented at least approximately perpendicular to the first leg and/or in that the rib is oriented at least approximately perpendicular to the second leg.

4. The connecting element according to claim 2,
characterized in that
the rib is connected, at its edge, to the first leg and the second leg at least substantially without gaps.

5. The connecting element according to claim 2,
characterized in that
the rib has at least one fastening point at which fastening of a shelf to the main body is enabled.

6. The connecting element according to claim 5,
characterized in that
the fastening point is in the form of a bore.

7. The connecting element according to claim 1,
characterized in that
the fastening point provided on the second leg is in the form of a bore.

8. The connecting element according to claim 1,
characterized in that
a locking mechanism, in particular a screw connection, which serves to lock the tongue strip in the profile can be actuated at the first leg from the inside.

9. The connecting element according to claim 1,
characterized in that
the main body is at least substantially monolithic.

10. A piece of furniture for a recreational vehicle, in particular a motorhome or a caravan, comprising at least one profile frame, multiple panels, and multiple connecting elements designed according to claim 1, wherein the main bodies of the connecting elements are fastened to profiles of the profile frame by means of the tongue strips and wherein the panels are connected to the main body by means of the fastening points of the second legs.

11. The piece of furniture according to claim 10,
characterized in that
at least one shelf is provided and in that the shelf is connected to the main body by means of fastening points provided on ribs of the main bodies.

12. A recreational vehicle, in particular motorhome or caravan, comprising at least one piece of furniture according to claim 1.

13. A method for producing a piece of furniture according to claim 1, wherein the main bodies of the connecting elements are fastened to profiles of the profile frame by means of the tongue strips and wherein the panels are connected to the main body by means of the fastening points of the second legs.
